(19) United States
(12) Patent Application Publication
(10) Pub. No.: US 2024/0326547 A1
(43) Pub. Date: Oct. 3, 2024

(54) HEAT EXCHANGE DEVICE AND BATTERY HEAT EXCHANGE SYSTEM

(71) Applicant: SANHUA (HANGZHOU) MICRO CHANNEL HEAT EXCHANGER CO., LTD., Hangzhou (CN)

(72) Inventors: Ning SONG, Hangzhou (CN); Hong LI, Hangzhou (CN); Yue ZHANG, Hangzhou (CN)

(21) Appl. No.: 18/616,764

(22) Filed: Mar. 26, 2024

(30) Foreign Application Priority Data
Mar. 27, 2023 (CN) 202320695666.8

(51) Int. Cl. B60H 1/00

(52) U.S. Cl. CPC B60H 1/00278

(57) ABSTRACT

A heat exchange device includes a first heat exchange component, which includes two first headers and at least one first heat exchange tube. The first heat exchange tube is communicated with the two first headers, and a size of the first heat exchange tube along a width direction is greater than a size of the first heat exchange tube along a thickness direction. The first heat exchange tube has a plurality of channels, and along a height direction of the first heat exchange tube, the first heat exchange tube at least includes a first heat exchange region and a second heat exchange region. The first heat exchange region is located below the second heat exchange region, and a flow area of the channel of the first heat exchange region is smaller than a flow area of the channel of the second heat exchange region.

### CROSS-REFERENCE TO RELATED APPLICATION

This application is based on and claims priority to Chinese Patent Application No. 202320695666.8 filed on Mar. 27, 2023, the entire contents of which are incorporated herein by reference for all purposes.

### FIELD

The present disclosure relates to the field of heat exchange technologies, and more particularly to a heat exchange device and a battery heat exchange system.

### BACKGROUND

With the development of economy and technology, an energy storage device such as a battery is widely promoted and used. Taking the battery as an example, the energy density and power demand of the battery are also increasing, and the heat generation of the battery is also increasing, resulting in an increase in the temperature of the battery during operation. In the related art, a heat exchange device exchanges heat with the battery, and is arranged on a side portion of the battery. However, since the temperature at a top of the battery is higher than the temperature at a bottom of the battery, there is still a temperature difference between the top and the bottom of the battery after the heat exchange through the heat exchange device, and the thermal management effect of the battery is not ideal.

### SUMMARY

Embodiments of a first aspect of the present disclosure provide a heat exchange device, the heat exchange device includes a first heat exchange component, the first heat exchange component includes two first headers and at least one first heat exchange tube, the first heat exchange tube is communicated with the two first headers, and a size of the first heat exchange tube along a width direction of the first heat exchange tube is greater than a size of the first heat exchange tube along a thickness direction of the first heat exchange tube; and the first heat exchange tube has a plurality of channels, and along the width direction of the first heat exchange tube, the first heat exchange component at least includes a first heat exchange region and a second heat exchange region, the first heat exchange region is located below the second heat exchange region, and a flow area of the channel of the first heat exchange region is smaller than a flow area of the channel of the second heat exchange region.

Embodiments of a second aspect of the present disclosure further provide a battery heat exchange system. The battery heat exchange system includes a battery and a heat exchange device, the heat exchange device is the heat exchange device according to the first aspect of the present disclosure, and the heat exchange device is configured to exchange heat with the battery. The first heat exchange component is located at a side portion of the battery, the battery is at least partially located between adjacent first heat exchange tubes, and the side portion of the battery is in contact with at least part of the first heat exchange tube.

### BRIEF DESCRIPTION OF THE DRAWINGS

FIG. 1 is a schematic view of a battery heat exchange system according to a specific embodiment of the present disclosure.

FIG. 2 is a schematic view of a heat exchange device in FIG. 1 in a specific embodiment.

FIG. 3 is a schematic view of a first heat exchange component in FIG. 2 in a specific embodiment.

FIG. 4 is a schematic view of a first heat exchange tube in FIG. 3 in a specific embodiment.

FIG. 5 is a partial enlarged view of Part I in FIG. 4.

FIG. 6 is a top view of the first heat exchange component in FIG. 3.

FIG. 7 is a sectional view of the first heat exchange component in FIG. 6 taken along an A-A direction in a specific embodiment.

FIG. 8 is a sectional view of the first heat exchange component in FIG. 6 taken along an A-A direction in another specific embodiment.

FIG. 9 is a schematic view of a battery heat exchange system according to another specific embodiment of the present disclosure.

FIG. 10 is a schematic view of a heat exchange device in FIG. 9 in a specific embodiment.

FIG. 11 is a schematic view of a first heat exchange component in FIG. 10 in a specific embodiment.

FIG. 12 is a schematic view of a first heat exchange tube in FIG. 11 in a specific embodiment.

FIG. 13 is a partial enlarged view of Part II in FIG. 12.

FIG. 14 is a top view of the first heat exchange tube in FIG. 12.

FIG. 15 is a sectional view of the first heat exchange tube in FIG. 14 taken along a B-B direction.

FIG. 16 is a schematic view of a second heat exchange component in FIG. 2 and FIG. 10 in a specific embodiment.

### DETAILED DESCRIPTION

In order to better understand the technical solution of the present disclosure, embodiments of the present disclosure are described in detail below in combination with the accompanying drawings.

It should be clarified that the described embodiments are only part of embodiments of the present disclosure, but not all of the embodiments. Based on the embodiments in the present disclosure, all other embodiments obtained by those skilled in the art without making creative efforts fall within the protection scope of the present disclosure.

Terms used in the embodiments of the present disclosure are for the purpose of describing specific embodiments only, and are not intended to limit the present disclosure. The singular forms of “a/an”, “said”, and “the” used in the embodiments of the present disclosure and the appended claims are also intended to include the plural form, unless the context clearly indicates other meanings.

It should be understood that the term “and/or” used herein is merely an association relationship describing the associated objects, indicating that there can be three kinds of relationships, for example, A and/or B can indicate the existence of A alone, the coexistence of A and B, and the existence of B alone. In addition, the character “/” herein generally indicates that the relationship between the former and latter associated objects has an “or” relationship.

It should be noted that the directional words such as “up”, “down”, “left”, “right” described in the embodiments of the present disclosure are described from the views shown in the accompanying drawings, and should not be understood as limiting the embodiments of the present disclosure. In addition, in the context, it should be understood that when an element is mentioned to be connected “above” or “below” another element, it can not only be directly connected “above” or “below” another element, but can also be indirectly connected “above” or “below” another element via an intervening element.

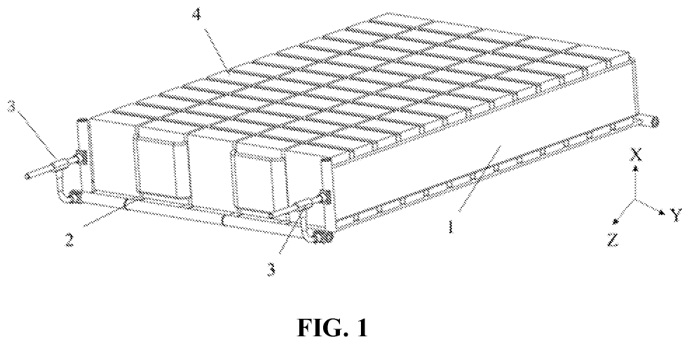

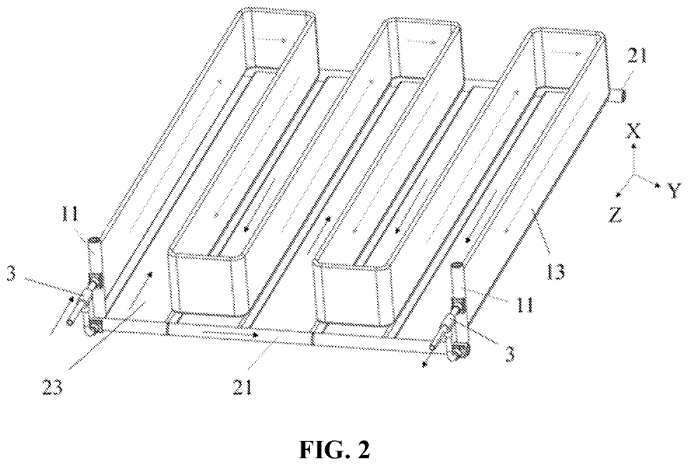

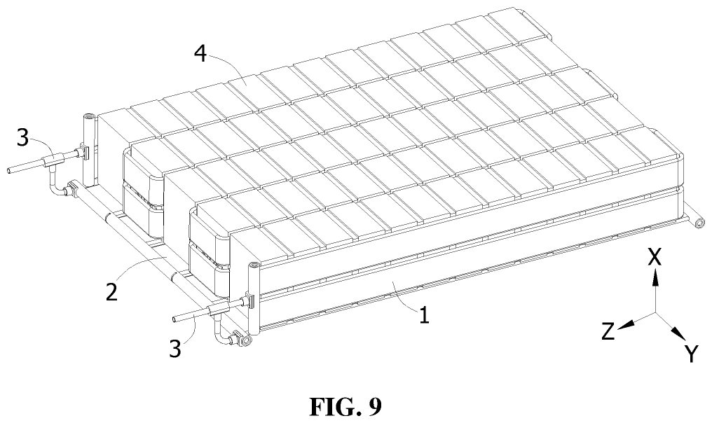

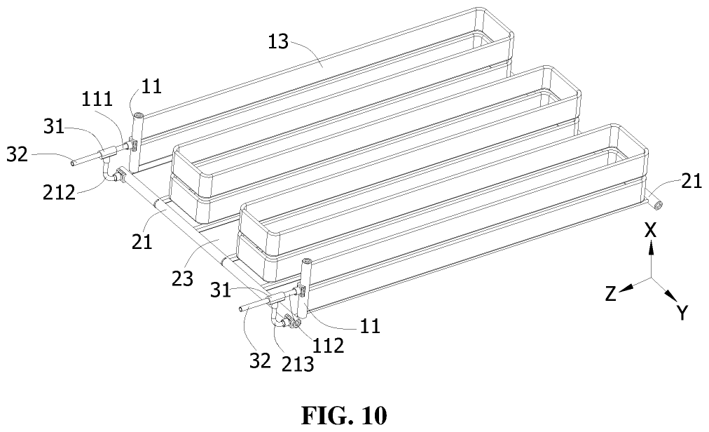

The embodiments of the present disclosure provide a heat exchange device. As shown in FIGS. 1 and 9, the heat exchange device at least includes a first heat exchange component 1 located on a side portion of an apparatus to be heat exchanged 4, and as shown in FIGS. 2 and 10, the first heat exchange component 1 includes two first headers 11 and at least one first heat exchange tube 13, the first heat exchange tube 13 extends along its length direction Z and is communicated with the two first headers 11, and a size of the first heat exchange tube 13 along its width direction X is greater than a size of the first heat exchange tube 13 along its thickness direction Y.

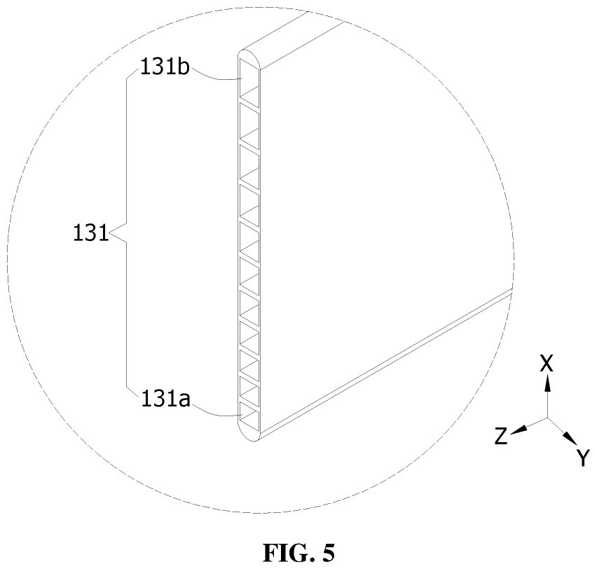

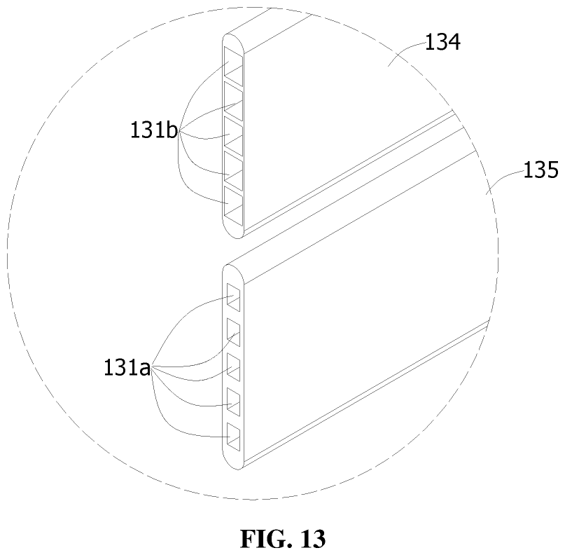

Specifically, the first heat exchange tube 13 has a plurality of channels 131, as shown in FIGS. 5 and 13. Along the width direction X of the first heat exchange tube 13, the first heat exchange tube 13 at least includes a first heat exchange region 131a and a second heat exchange region 131b. The first heat exchange region 131a is located below the second heat exchange region 131b, that is, the first heat exchange region 131a is configured to heat exchange with a bottom of the side portion of the apparatus to be heat exchanged 4, and the second heat exchange region 131b is configured to heat exchange with a top of the side portion of the apparatus to be heat exchanged 4.

The “top” and “bottom” mentioned herein means that, with reference to the width direction X of the first heat exchange tube 13 shown in FIGS. 2 and 10, a direction indicated by the arrow of the width direction X is a direction from bottom to top, and a direction opposite to the direction indicated by the arrow of the width direction X is a direction from top to bottom. The present disclosure defines a relative position between the first heat exchange region 131a and the second heat exchange region 131b, and the arrangement satisfying the relative position therebetween (the first heat exchange region 131a being located below the second heat exchange region 131b in the width direction X) is within the protection scope of the present disclosure.

In the first heat exchange tube 13, a flow area of the channel 131 in the first heat exchange region 131a is smaller than a flow area of the channel 131 in the second heat exchange region 131b. That is, during the working of the first heat exchange tube 13, less heat exchange medium may flow in the first heat exchange region 131a located at the bottom, with a smaller amount of heat exchange with the apparatus to be heat exchanged 4; and more heat exchange medium may flow in the second heat exchange region 131b located at the top, with a larger amount of heat exchange with the apparatus to be heat exchanged 4. At the same time, during the working of the apparatus to be heat exchanged 4, the temperature at its top is higher than the temperature at its bottom. When the heat exchange device exchanges heat with the apparatus to be heat exchanged 4, the second heat exchange region 131b located at the top exchanges more heat with the top of the apparatus to be heat exchanged 4, and the first heat exchange region 131a located at the bottom exchanges relatively less heat with the bottom of the apparatus to be heat exchanged 4. Therefore, after the heat exchange through the first heat exchange component 1, the temperature of the apparatus to be heat exchanged 4 may be reduced, so as to allow the apparatus to be heat exchanged 4 to work at a suitable temperature, and also the temperature difference between the top and the bottom of the apparatus to be heat exchanged 4 may be reduced, so that the heat exchange effect of the heat exchange device on the apparatus to be heat exchanged 4 is better.

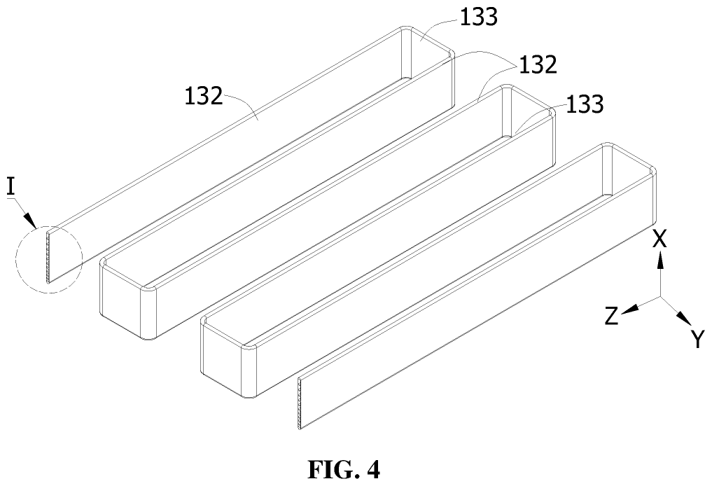

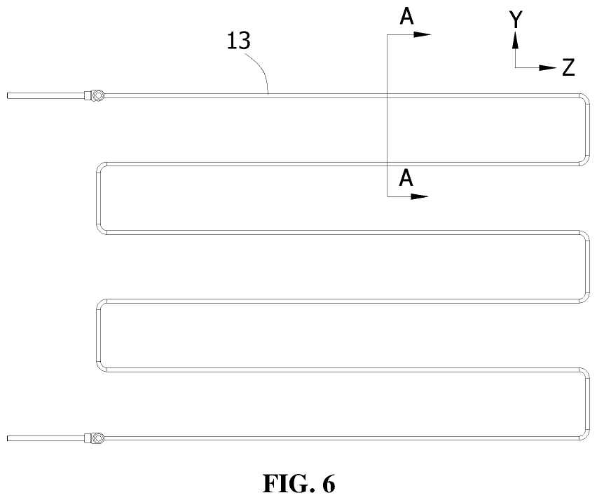

The first header 11 is provided with a first blocking cover 12 at either end along its axis direction, and the first blocking cover 12 is configured to seal and block the first header 11 to prevent the heat exchange medium from leaking from the two ends of the first header 11. In a specific embodiment, as shown in FIGS. 4-8, the first heat exchange region 131a and the second heat exchange region 131b are located at the same first heat exchange tube 13, that is, in the first heat exchange tube 13, and at least two channels 131 have different flow areas, thus realizing that the flow area of the channel 131 at the top of the first heat exchange component 1 is larger than the flow area of the channel 131 at the bottom of the first heat exchange component 1.

In some specific embodiments, the first heat exchange region 131a may include one channel 131, and the second heat exchange region 131b may also include one channel 131. In this case, along the width direction X of the first heat exchange tube 13, the channel 131 located at a bottom of the first heat exchange tube 13 is the first heat exchange region 131a, and the channel 131 located at a top of the first heat exchange tube 13 is the second heat exchange region 131b. In other embodiments, the first heat exchange region 131a and the second heat exchange region 131b each may include a plurality of channels 131, and in the first heat exchange region 131a, the flow areas of the respective channels 131 may be the same or different. In the second heat exchange region 131b, the flow areas of the respective channels 131 may be the same or different, as long as the flow area of each channel 131 in the second heat exchange region 131b is greater than the flow area of each channel 131 in the first heat exchange region 131a.

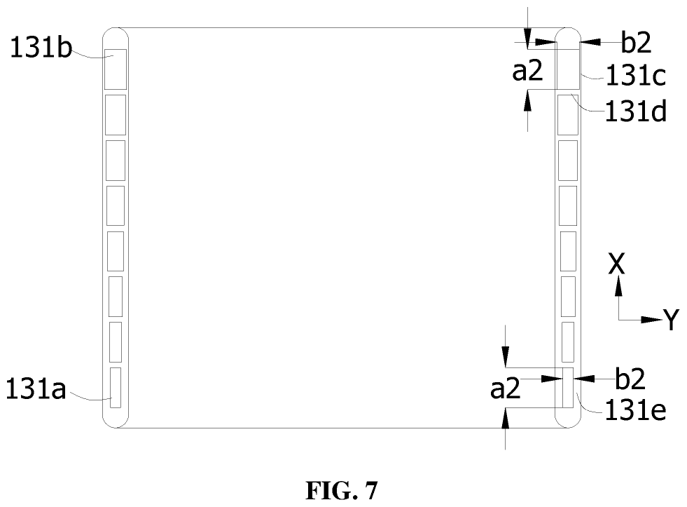

In the embodiment shown in FIG. 7, along the thickness direction Y of the first heat exchange tube 13, the channel 131 of the first heat exchange region 131a has a first side wall 131c, the channel 131 of the second heat exchange region 131b has a second side wall 131e, and a thickness of at least part of the first side wall 131c is less than a thickness of at least part of the second side wall 131e, so that a size b2 of the channel of the first heat exchange region 131a along the thickness direction Y of the first heat exchange tube 13 is smaller than a size b2 of the channel of the second heat exchange region 131b along the thickness direction Y of the first heat exchange tube 13. Along the width direction X of the first heat exchange tube 13, a width a2 of each channel 131 is the same, so that a channel hole of the channel of the first heat exchange region 131a is smaller than a channel hole of the channel of the second heat exchange region 131b, thus realizing that the flow area of the channel 131 of the first heat exchange region 131a is smaller than the flow area of the channel 131 of the second heat exchange region 131b.

In some specific embodiments, the first heat exchange region 131a may include one channel 131, and the second heat exchange region 131b may also include one channel 131. In this case, along the width direction X of the first heat exchange tube 13, the channel 131 located at the bottom of the first heat exchange tube 13 is the first heat exchange region 131a, and the channel 131 located at the top of the first heat exchange tube 13 is the second heat exchange region 131b.

In other embodiments, the first heat exchange region 131a and the second heat exchange region 131b each may include a plurality of channels 131. In the first heat exchange region 131a, the flow areas of the respective channels 131 may be the same or different. In the second heat exchange region 131b, the flow areas of the respective channels 131 may be the same or different, as long as the flow area of each channel 131 of the second heat exchange region 131b is greater than the flow area of each channel 131 of the first heat exchange region 131a.

In the embodiment shown in FIG. 7, along a direction from the bottom to the top of the first heat exchange tube 13, thicknesses of the side walls of the respective channels 131 along the thickness direction Y of the first heat exchange tube 13 gradually decreases, so that the sizes b2 of the respective channels 131 along the thickness direction Y of the first heat exchange tube 13 gradually increase. As a result, the flow areas of the respective channels 131 gradually increase along the direction from the bottom to the top of the first heat exchange tube 13, and the heat exchange amount of the first heat exchange tube 13 gradually increases along the direction from the bottom to the top of the first heat exchange tube 13. Thus, the heat dissipation effect of the heat exchange device on the apparatus to be heat exchanged 4 is further improved, and the temperature uniformity of the apparatus to be heat exchanged 4 from the bottom to the top is higher.

In addition, in the embodiment shown in FIG. 7, the first heat exchange tube 13 may also include a third heat exchange region (not shown in the drawings), and along the width direction X of the first heat exchange tube 13, the third heat exchange region is located between the first heat exchange region 131a and the second heat exchange region 131b. Along the direction from the bottom to the top of the first heat exchange tube 13, the flow areas of the channels 131 of the third heat exchange region may be the same, may increase gradually, may decrease gradually, and may increase and decrease in different positions simultaneously, that is, the embodiment of the present disclosure does not limit the flow area of the channel 131 of the third heat exchange region.

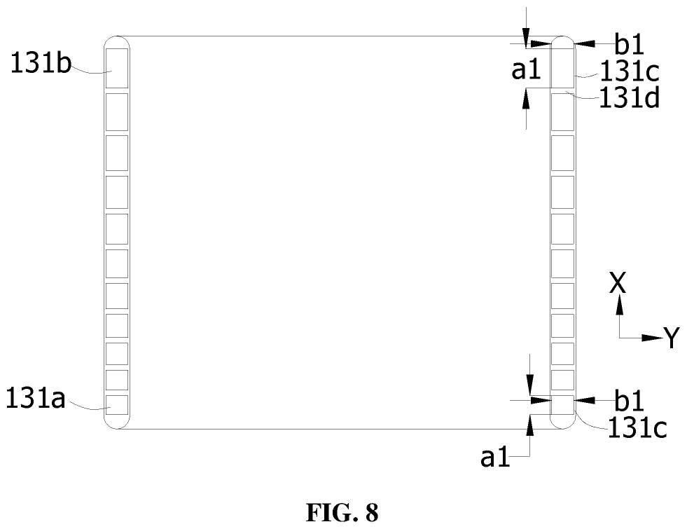

In the embodiment shown in FIG. 8, along the width direction X of the first heat exchange tube 13, a width a1 of the channel 131 of the first heat exchange region 131a is smaller than a width a1 of the channel 131 of the second heat exchange region 131b, and along the thickness direction Y of the first heat exchange tube 13, the channel 131 of the first heat exchange region 131a has the first side wall 131c, the channel 131 of the second heat exchange region 131b has the second side wall 131e, and the thickness of the first side wall 131c is equal to the thickness of the second side wall 131e. Along the thickness direction Y of the first heat exchange tube 13, a thickness b1 of the channel 131 of the first heat exchange region 131a is the same with a thickness b1 of the channel 131 of the second heat exchange region 131b, so that the channel hole of the channel 131 of the first heat exchange region 131a is smaller than the channel hole of the channel 131 of the second heat exchange region 131b, thus realizing that the flow area of the channel 131 of the first heat exchange region 131a is smaller than the flow area of the channel 131 of the second heat exchange region 131b.

In addition, along the width direction Y of the first heat exchange tube 13, the first heat exchange tube 13 also has a third side wall 131d, which is configured to separate adjacent two channels of the first heat exchange tube 13 along the width direction Y. In the embodiment shown in FIG. 8, in the first heat exchange tube 13, the third side walls 131d of the respective channels 131 have the same size along the width direction X of the first heat exchange tube 13.

In other embodiments, sizes of at least part of the third side walls 131d of the first heat exchange tube 13 along the width direction X of the first heat exchange tube 13 are different. For example, the size of the third side wall 131d of the channel 131 of the first heat exchange region 131a along the width direction X of the first heat exchange tube 13 is larger than the size of the third side wall 131d of the channel 131 of the second heat exchange region 131b along the width direction X of the first heat exchange tube 13, thus achieving that, along the width direction X of the first heat exchange tube 13, the width a1 of the channel 131 of the first heat exchange region 131a is smaller than the width a1 of the channel 131 of the second heat exchange region 131b.

In the embodiment shown in FIG. 8, along the direction from the bottom to the top of the first heat exchange tube 13, the widths a1 of the respective channels 131 along the width direction X of the first heat exchange tube 13 gradually increase, so that when the thicknesses b1 of the respective channels 131 are the same, along the direction from the bottom to the top of the first heat exchange tube 13, the flow areas of the respective channels 131 gradually increase, so that the heat exchange amount of the first heat exchange tube 13 gradually increases along the direction from the bottom to the top of the first heat exchange tube 13, thus further improving the heat dissipation effect of the heat exchange device on the apparatus to be heat exchanged 4, and making the temperature uniformity of the apparatus to be heat exchanged 4 from the bottom to the top higher. Along the direction from the top to the bottom of the first heat exchange tube 13, the widths a1 of the respective channels 131 along the width direction X of the first heat exchange tube 13 gradually decrease, and the reduction ratio may be 0.9, or other ratios less than 1.

In addition, in the embodiment shown in FIG. 8, the first heat exchange tube 13 may also include the third heat exchange region (not shown in the drawings), and along the width direction X of the first heat exchange tube 13, the third heat exchange region is located between the first heat exchange region 131a and the second heat exchange region 131b. Along the direction from the bottom to the top of the first heat exchange tube 13, the flow areas of the channels 131 of the third heat exchange region may be the same, may increase gradually, may decrease gradually, and may increase and decrease in different positions simultaneously, that is, the embodiment of the present disclosure does not limit the flow area of the channel 131 of the third heat exchange region.

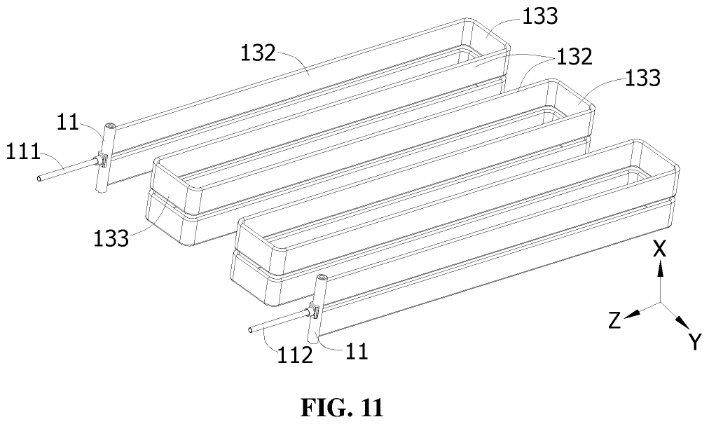

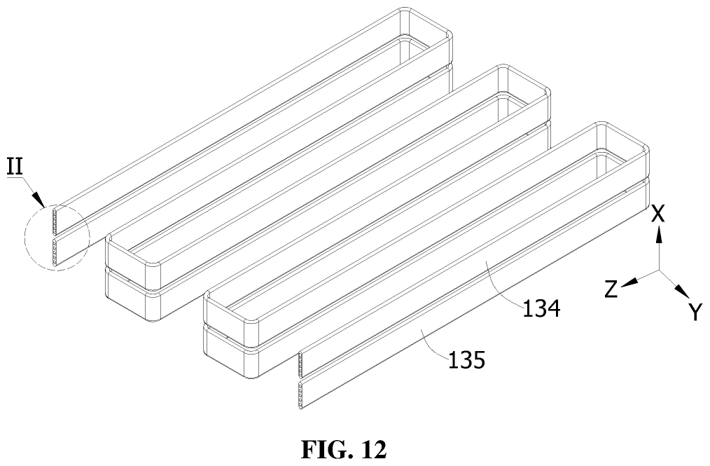

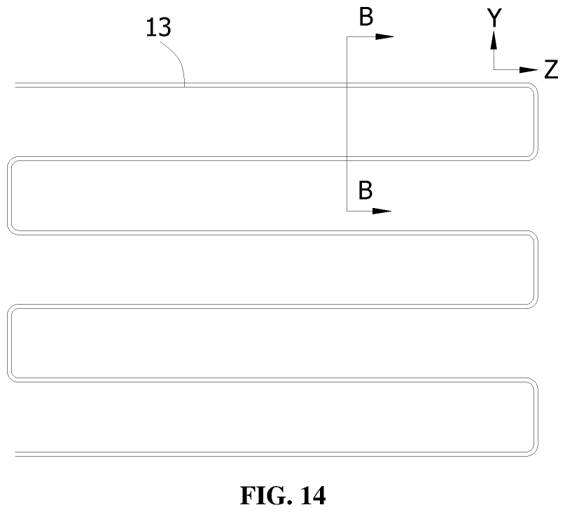

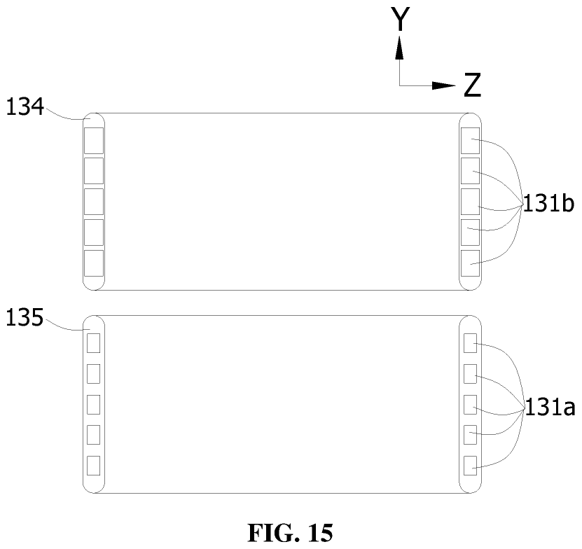

In another specific embodiment, as shown in FIGS. 9-15, the first heat exchange component 1 may include at least two first heat exchange tubes 13. The flow areas of the channels 131 of the same first heat exchange tube 13 are the same, and the at least two first heat exchange tubes 13 are arranged along the width direction X of the first heat exchange tube 13. The respective first heat exchange tubes 13 are connected in parallel with each other, that is, the heat exchange medium in the first header 11 may enter the first heat exchange tubes 13, respectively. In the first heat exchange tubes 13, the first heat exchange tube 13 located at the bottom is a bottom heat exchange tube 135, the first heat exchange tube 13 located at the top is a top heat exchange tube 134, the first heat exchange region 131a is the bottom heat exchange tube 135, and the second heat exchange region 131b is the top heat exchange tube 134. In the embodiment, the first heat exchange region 131a and the second heat exchange region 131b in the first heat exchange tube 13 each include the plurality of channels 131.

As shown in FIG. 13, the flow area of the channel 131 of the bottom heat exchange tube 135 is smaller than the flow area of the channel 131 of the top heat exchange tube 134, that is, in the embodiment, by arranging the first heat exchange tubes 13, it is convenient to achieve that the flow area of the channel 131 of the first heat exchange region 131a is smaller than the flow area of the channel 131 of the second heat exchange region 131b. When assembling the heat exchange device, only the heat exchange tubes with the channels 131 of different flow areas need to be selected, and there is no need to process the heat exchange tubes with the channels 131 of different flow areas, thus reducing the processing difficulty of the first heat exchange component 1, while improving the heat exchange effect of the heat exchange device.

Specifically, when the first heat exchange component 1 includes more than two first heat exchange tubes 13, the flow areas of the channels 131 of the same first heat exchange tube 13 are the same, and the flow areas of the channels 131 of other first heat exchange tubes 13 located between the bottom heat exchange tube 135 and the top heat exchange tube 134 may be the same or different. For example, the first heat exchange component 1 may include five first heat exchange tubes 13, three first heat exchange tubes 13 are arranged between the bottom heat exchange tube 135 and the top heat exchange tube 134, and the flows area of the channels of the three first heat exchange tubes 13 may be the same. Or, the flow areas of the channels of the first heat exchange tube 13 adjacent to the bottom heat exchange tube 135 may be the same with the flow areas of the channels of the bottom heat exchange tube 135, and the flow areas of the channels of the other two first heat exchange tubes 13 are greater than the flow areas of the channels of the first heat exchange tube 13 adjacent to the bottom heat exchange tube 135. It may also be that the flow areas of the channels of the first heat exchange tube 13 adjacent to the top heat exchange tube 134 are the same with the flow areas of the channels of the top heat exchange tube 134, and the flow areas of the channels of the other two first heat exchange tubes 13 are smaller than the flow areas of the channels of the top heat exchange tube 134. The embodiment of the present disclosure does not limit the flow areas of the channels of the first heat exchange tube 13 between the top heat exchange tube 134 and the bottom heat exchange tube 135 in the first heat exchange component 1.

In a specific embodiment, the flow areas of the channels 131 of the respective first heat exchange tubes 13 gradually increase along the direction from bottom to top.

For example, when the first heat exchange component 1 includes three first heat exchange tubes 13, namely the top heat exchange tube, a middle heat exchange tube, and the bottom heat exchange tube, the flow areas of the respective channels 131 of the top heat exchange tube are the same, the flow areas of the respective channels 131 of the middle heat exchange tube are the same, the flow areas of the respective channels 131 of the bottom heat exchange tube are the same, the flow area of the channel 131 of the top heat exchange tube is greater than the flow area of the channel 131 of the middle heat exchange tube, and the flow area of the channel 131 of the middle heat exchange tube is larger than the flow area of the channel 131 of the bottom heat exchange tube. The situation where the first heat exchange component 1 includes four or more first heat exchange tubes 13 is similar to this, which will not be repeated here.

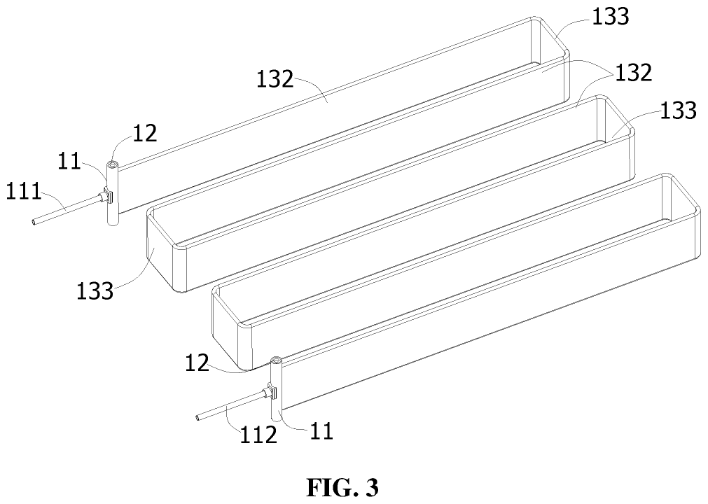

In the above embodiments, as shown in FIGS. 3, 4, and 11, the first heat exchange tube 13 includes at least one first tube segment 132 and at least one second tube segment 133, and the first tube segment 132 and the second tube segment 133 are arranged adjacent to each other. As shown in FIGS. 3 and 10, one end of the first tube segment 132 is communicated with the first header 11, and the other end of the first tube segment 132 is communicated with the second tube segment 133 adjacent to the first tube segment 132; and/or, one end of the second tube segment 133 is communicated with the first header 11, and the other end of the second tube segment 133 is communicated with the first tube segment 132 adjacent to the second tube segment 133.

When the first heat exchange tube 13 includes a plurality of first tube segments 132, the plurality of first tube segments 132 are arranged at intervals along the thickness direction Y of the first heat exchange tube 13, and when the first heat exchange tube 13 includes a plurality of second tube segments 133, the plurality of second tube segments 133 are arranged at intervals along the length direction Z of the first heat exchange tube 13, so that the first heat exchange tube 13 is distributed in a serpentine shape, the first tube segments 132 and the second tube segments 133 of the first heat exchange tube 13 enclose one or more U-shaped spaces, and each U-shaped space is configured to accommodate the apparatus to be heat exchanged 4. Thus, heat can be exchanged with a plurality of side portions of the apparatus to be heat exchanged 4, and the first heat exchange tube 13 of the serpentine shape occupies a small volume.

As shown in FIGS. 1 and 9, in the first heat exchange tube 13, the first tube segment 132 and the second tube segment 133 are configured to exchange heat with three adjacent side portions of the apparatus to be heat exchanged 4, respectively, thus improving the heat exchange effect on the apparatus to be heat exchanged 4.

In the above embodiments, as shown in FIGS. 1 and 9, the heat exchange device may further includes a second heat exchange component 2, and along the width direction X of the first heat exchange tube 13, the second heat exchange component 2 is located below the first heat exchange component 1. When the heat exchange device is used for heat dissipation of the apparatus to be heat exchanged 4, the second heat exchange component 2 is located at the bottom of the apparatus to be heat exchanged 4, so as to dissipate heat from the bottom of the apparatus to be heat exchanged 4. In the embodiment, the heat exchange device exchanges heat with the side portion of the apparatus to be heat exchanged 4 through the first heat exchange component 1, and exchanges heat with the bottom of the apparatus to be heat exchanged 4 through the second heat exchange component 2. Thus, the heat is exchanged with the apparatus to be heat exchanged 4 from a plurality of directions, and the heat exchange effect on the apparatus to be heat exchanged 4 is improved.

As shown in FIGS. 2 and 10, the first heat exchange component 1 includes a first inlet tube 111 and a first outlet tube 112, the second heat exchange component 2 includes a second inlet tube 212 and a second outlet tube 213, the first inlet tube 111 and the second inlet tube 212 are located on a same side of the heat exchange device, and the first outlet tube 112 and the second outlet tube 213 are located on another same side of the heat exchange device, thus reducing the lengths of the first inlet tube 111, the first outlet tube 112, the second inlet tube 212 and the second outlet tube 213, simplifying the structure of the heat exchange device, and facilitating the installation of the apparatus to be heat exchanged 4.

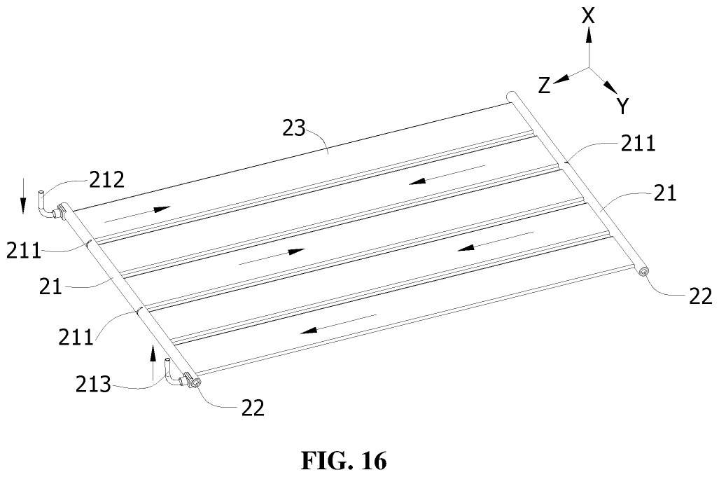

In a specific embodiment, as shown in FIG. 16, the second heat exchange component 2 includes two second headers 21 and at least one second heat exchange tube 23. The second heat exchange tube 23 extends along the length direction Z of the first heat exchange tube 13 and is communicated with the two second headers 21. The heat exchange medium flows in the at least one second heat exchange tube 23, thus dissipating heat of the apparatus to be heat exchanged 4 from the bottom of the apparatus to be heat exchanged 4. The structure of the second heat exchange component 2 in the embodiment shown in FIG. 16 has the advantage of high heat exchange efficiency, and thus the heat dissipation effect of the heat exchange device on the apparatus to be heat exchanged 4 may be further improved.

As shown in FIG. 16, the second header 21 is provided with a second blocking cover 22 at either end along its axis direction, so as to prevent the heat exchange medium from leaking from the two ends of the second header 21.

In other embodiments, the second heat exchange component 2 may also be a liquid cooling plate formed by stamping. Therefore, the present disclosure does not limit the specific structure of the second heat exchange component 2.

In addition, as shown in FIGS. 2 and 10, the heat exchange device may also include a third component 3, the third component 3 includes a joint 31 and an external pipeline 32. The joint 31 is communicated with the external pipeline 32, the first inlet tube 111, and the second inlet tube 212. Or, the joint 31 is communicated with the external pipeline 32, the first outlet tube 112, and the second outlet tube 213. When the heat exchange device is working, the heat exchange medium enters the first inlet tube 111 and the second inlet tube 212 through the external pipeline 32, enters the first header 11 through the first inlet tube 111, enters the second header 21 through the second inlet tube 212, then enters a heat exchange medium flow channel of the first heat exchange component 1 and a heat exchange medium flow channel of the second heat exchange component 2, and after exchanging heat with the apparatus to be heat exchanged 4, flows out of the heat exchange device through the first outlet tube 112 and the second outlet tube 213, respectively, thus completing one time of heat exchange.

As shown in FIG. 2, while flowing in the first header 11, the heat exchange medium may enter each first heat exchange tube 13, sequentially flow through the first tube segment 132 and the second tube segment 133 distributed in the serpentine shape in the first heat exchange tube 13, finally converge to another first header 11 communicated with the first outlet tube 112, and flow out through the first outlet tube 112.

As shown in FIG. 16, a partition plate 211 may be arranged inside the second header 21, to divide the second header 21 into a plurality of cavities communicated with the second heat exchange tubes 23. In an actual production, the flow of the heat exchange medium in the second heat exchange component 2 is arranged based on the positions of the second inlet tube 212 and the second outlet tube 213, as well as the number of the second heat exchange tubes 23. The number of the second heat exchange tubes 23 is determined based on the number of the apparatuses to be heat exchanged 4.

In the embodiment shown in FIG. 16, the second inlet tube 212 and the second outlet tube 213 are connected to the same second header 21, and the second heat exchange component 2 includes five second heat exchange tubes 23. A flow direction of the heat exchange medium in each second heat exchange tube 23 is shown by the arrow in FIG. 16. Based on this, two partition plates 211 are arranged in the second header 21 connected with the second inlet tube 212 and the second outlet tube 213, thus dividing the second header 21 into three cavities; and one partition plate 211 is arranged in another second header 21, thus dividing the second header 21 into two cavities.

As shown in FIGS. 2 and 16, while flowing in the second header 21, the heat exchange medium may enter the first second heat exchange tube 23, then enter another second header 21, and then enter another second heat exchange tube 23 and the second header 21. The above process is repeated, and finally, the heat exchange medium converges to the second outlet tube 213, and flows out of the second heat exchange component 2 through the second outlet tube 213. At the same time, the first outlet tube 112 and the second outlet tube 213 are connected to the external pipeline 32 through the joint 31, thus achieving the circulation of the heat exchange medium in the heat exchange device.

The heat exchange devices described in the above embodiments may be used for heat exchange of a battery, that is, the heat exchange device 4 may be the battery.

The embodiment of the present disclosure also provides a battery heat exchange system. As shown in FIGS. 1 and 9, the battery heat exchange system includes a battery and a heat exchange device, the heat exchange device is configured to exchange heat with the battery, and the heat exchange device is the heat exchange device according to any one of the above embodiments. As shown in FIGS. 1 and 9, the first heat exchange component 1 of the heat exchange device is located on a side portion of the battery. When the first heat exchange tube 13 includes a plurality of first tube segments 132, the plurality of first tube segments 132 are arranged at intervals along the thickness direction Y of the first heat exchange tube 13, and when the first heat exchange tube 13 includes a plurality of second tube segments 133, the plurality of second tube segments 133 are arranged at intervals along the length direction Z of the first heat exchange tube 13, so that the first heat exchange tube 13 is distributed in the serpentine shape, the first tube segments 132 and the second tube segments 133 enclose one or more U-shaped spaces, and each U-shaped space is configured to accommodate the battery, so as to exchange heat with a plurality of side portions of the battery, and improve the heat exchange effect on the battery. Moreover, in the first heat exchange tube 13, the flow area of the channel 131 of the first heat exchange region 131a is smaller than the flow area of the channel 131 of the second heat exchange region 131b. That is, during the working of the first heat exchange tube 13, less heat exchange medium may flow in the first heat exchange region 131a located at the bottom, with a smaller amount of heat exchange with the battery, and more heat exchange medium may flow in the second heat exchange region 131b located at the top, with a larger amount of heat exchange with the battery. Moreover, during the working of the battery, the temperature of its top is higher than the temperature of its bottom. When the heat exchange device exchanges heat with the battery, the second heat exchange region 131b located at the top exchanges more heat with a top of the battery, while the first heat exchange region 131a located at the bottom exchanges relatively less heat with a bottom of the battery. Therefore, after the heat exchange through the first heat exchange component 1, the temperature difference between the top and bottom of the battery is reduced, and thus the heat exchange effect of the heat exchange device on the battery is better.

In the above embodiments, as shown in FIGS. 1 and 9, the battery may include a plurality of battery modules, which are distributed along the length direction Z of the first heat exchange tube 13 to form a battery string. A plurality of battery strings are distributed along the thickness direction Y of the first heat exchange tube 13. A size of the second heat exchange tube 23 along the thickness direction Y of the first heat exchange tube 13 is the same with a size of the battery along the thickness direction Y of the first heat exchange tube 13, so that the second heat exchange tube 23 is compatible with the battery and there is no gap therebetween. Thus, the whole bottom of the battery is the heat exchange area, the heat exchange amount between the second heat exchange tube 23 and the battery is improved, and the heat exchange effect of the heat exchange device on the battery is further improved.

In the above embodiments, the first heat exchange tube 13 is in direct contact with the battery adjacent to the first heat exchange tube 13 or in contact with the battery adjacent to the first heat exchange tube 13 through a thermal conductive element; and/or, the second heat exchange tube 23 is in direct contact with the battery or in contact with the battery through a thermal conductive element.

When the first heat exchange tube 13 is in contact with the battery through the thermal conductive element, and the second heat exchange tube 23 is in contact with the battery through the thermal conductive element, the thermal conductive element may reduce the contact thermal resistance between the heat exchange tube and the battery, thus further improving the heat exchange effect of the heat exchange device on the battery.

Specifically, the thermal conductive element may be a thermal conductive adhesive, which not only may reduce the contact thermal resistance between the heat exchange tube and the battery, but also may play a role in fixing the heat exchange tube with the battery.

The above descriptions are only preferred embodiments of the present disclosure and are not intended to limit the present disclosure. For those skilled in the art, the present disclosure may have various modifications and variations. Any modifications, equivalent replacements, improvements, etc. made within the spirit and principle of the present disclosure shall be included within the scope of protection of the present disclosure.

1. A heat exchange device, wherein the heat exchange device comprises a first heat exchange component, the first heat exchange component comprises two first headers and at least one first heat exchange tube, the first heat exchange tube is communicated with the two first headers, and a size of the first heat exchange tube along a width direction of the first heat exchange tube is greater than a size of the first heat exchange tube along a thickness direction of the first heat exchange tube,
wherein the first heat exchange tube has a plurality of channels, and along the width direction of the first heat exchange tube, the first heat exchange component at least comprises a first heat exchange region and a second heat exchange region, and a flow area of the channel of the first heat exchange region is smaller than a flow of the channel of the second heat exchange region.

2. The heat exchange device according to claim 1, wherein the first heat exchange region and the second heat exchange region are arranged in the same first heat exchange tube; and
along the thickness direction of the first heat exchange tube, the first heat exchange region comprises a first side wall, the second heat exchange region comprises a second side wall, and a thickness of at least part of the first side wall is greater than a thickness of at least part of the second side wall.

3. The heat exchange device according to claim 1, wherein the first heat exchange region and the second heat exchange region are arranged in the same first heat exchange tube; and
along the width direction of the first heat exchange tube, a width of the channel of the first heat exchange region is smaller than a width of the channel of the second heat exchange region.

4. The heat exchange device according to claim 2, wherein along a direction from a bottom to a top of the first heat exchange tube, the flow areas of the respective channels increase.

5. The heat exchange device according to claim 1, wherein the first heat exchange component comprises at least two first heat exchange tubes, the at least two first heat exchange tubes are arranged along the width direction of the first heat exchange tube, the respective first heat exchange tubes are connected in parallel with each other, the first heat exchange region is the first heat exchange tube located at the bottom, and the second heat exchange region is the first heat exchange tube located at the top.

6. The heat exchange device according to claim 5, wherein along a direction from bottom to top, the flow areas of the channels of the at least two first heat exchange tubes increase.

7. The heat exchange device according to claim 1, wherein the first heat exchange tube comprises at least one first tube segment and at least one second tube segment, and the first tube segment and the second tube segment are arranged adjacent to each other; when the first heat exchange tube comprises a plurality of first tube segments, the plurality of first tube segments are arranged at intervals along the thickness direction of the first heat exchange tube; and when the first heat exchange tube comprises a plurality of second tube segments, the plurality of second tube segments are arranged at intervals along a length direction of the first heat exchange tube.

8. The heat exchange device according to claim 7, wherein one end of the first tube segment is communicated with the first header, and the other end of the first tube segment is communicated with the second tube segment adjacent to the first tube segment.

9. The heat exchange device according to claim 7, wherein one end of the second tube segment is communicated with the first header, and the other end of the second tube segment is communicated with a first tube segment adjacent to the second tube segment.

10. The heat exchange device according to claim 7, wherein one end of the first tube segment is communicated with the first header, and the other end of the first tube segment is communicated with the second tube segment adjacent to the first tube segment; and
one end of the second tube segment is communicated with the first header, and the other end of the second tube segment is communicated with a first tube segment adjacent to the second tube segment.

11. The heat exchange device according to claim 1, wherein the heat exchange device further comprises a second heat exchange component, the second heat exchange component is located below the first heat exchange component, the first heat exchange component comprises a first inlet tube and a first outlet tube, and the second heat exchange component comprises a second inlet tube and a second outlet tube; and
the first inlet tube and the second inlet tube are located on a same side of the heat exchange device, and the first outlet tube and the second outlet tube are located on another same side of the heat exchange device.

12. The heat exchange device according to claim 11, wherein the second heat exchange component comprises two second headers and at least one second heat exchange tube, the second heat exchange tube extends along the length direction of the first heat exchange tube and is communicated with the two second headers.

13. The heat exchange device according to claim 11, wherein the heat exchange device further comprises a joint and an external pipeline; and
wherein the joint is communicated with the external pipeline, the first inlet tube and the second inlet tube.

14. The heat exchange device according to claim 11, wherein the heat exchange device further comprises a joint and an external pipeline; and
the joint is communicated with the external pipeline, the first outlet tube and the second outlet tube.

15. The heat exchange device according to claim 11, wherein the heat exchange device further comprises:
a first joint and a first external pipeline, the first joint being communicated with the first external pipeline, the first inlet tube and the second inlet tube; and
a second joint and a second external pipeline, the second joint being communicated with the second external pipeline, the first outlet tube and the second outlet tube.

16. A battery heat exchange system, comprising a battery and a heat exchange device, wherein the heat exchange device is configured to exchange heat with the battery, and comprises a first heat exchange component, the first heat exchange component comprises two first headers and at least one first heat exchange tube, the first heat exchange tube is communicated with the two first headers, and a size of the first heat exchange tube along a width direction of the first heat exchange tube is greater than a size of the first heat exchange tube along a thickness direction of the first heat exchange tube,
wherein the first heat exchange tube has a plurality of channels, and along the width direction of the first heat exchange tube, the first heat exchange component at least comprises a first heat exchange region and a second heat exchange region, and a flow area of the channel of the first heat exchange region is smaller than a flow of the channel of the second heat exchange region,
wherein a side portion of the battery is in contact with at least part of the first heat exchange tube, at least one of the first heat exchange region and the second heat exchange region is in at least partial contact with the battery, and the first heat exchange region is closer to a lower end of the battery than the second heat exchange region.

17. The battery heat exchange system according to claim 16, wherein the heat exchange device further comprises a second heat exchange component, the second heat exchange component is located on a side of the first heat exchange tube along a width direction of the first heat exchange tube, and along the width direction of the first heat exchange tube, the second heat exchange component is located below the battery, and a bottom of the battery is in at least partial contact with the second heat exchange component; and
the second heat exchange component comprises a second heat exchange tube, and along the thickness direction of the first heat exchange tube, the second heat exchange tube has the same size as the battery.

18. The battery heat exchange system according to claim 16, wherein the first heat exchange tube is in direct contact with the battery adjacent to the first heat exchange tube or is in contact with the battery adjacent to the first heat exchange tube through a thermal conductive element.

19. The battery heat exchange system according to claim 16, wherein the second heat exchange tube is in direct contact with the battery or is in contact with the battery through a thermal conductive element.

20. The battery heat exchange system according to claim 16, wherein the first heat exchange tube is in direct contact with the battery adjacent to the first heat exchange tube or is in contact with the battery adjacent to the first heat exchange tube through a thermal conductive element; and
the second heat exchange tube is in direct contact with the battery or is in contact with the battery through another thermal conductive element.
